(19) United States
(12) Patent Application Publication
(10) Pub. No.: US 2002/0035497 A1
(43) Pub. Date: Mar. 21, 2002

(54) System and method for utility enterprise management

(76) Inventors: Jeff Mazereeuw, Newmarket (CA); Marzio Pozzuoli, Maple (CA); Norris Woodruff, Toronto (CA); Claudio Cargnelli, Toronto (CA)

Correspondence Address: Kevin T. Duncan, Esq., Hunton & Williams, Suite 1200, 1900 K Street, NW, Washington, DC, 20006-1109, US

(21) Appl. No.: 09/877,226

(22) Filed: Jun. 11, 2001

Related U.S. Application Data
(60) Provisional application No. 60/210,487, filed on Jun. 9, 2000.

(51) Int. Cl. G06F 17/60

(52) U.S. Cl. 705/7

(57) ABSTRACT

A system and method for monitoring a utility substation is provided. The system for monitoring a utility substation includes monitoring equipment connected to a utility substation for monitoring operating conditions of the utility substation. The monitoring equipment is connected to an application service provider through a first communication network. One or more network interface devices are connected to the application service provider by a second communication network, which may be the same communication network as the first communication network. The one or more network interface devices receive notification of operating conditions of the utility substation monitored by the monitoring equipment through the application service provider.

### CROSS REFERENCE TO RELATED APPLICATIONS

This application claims the benefit of provisional patent application Serial No. 60/210,487, filed Jun. 9, 2000, the disclosure of which is incorporated herein by reference.

### BACKGROUND OF THE INVENTION

The present invention generally relates to enterprise management. More particularly, the present invention relates to systems and methods for remote management of utility enterprises.

Comprehensive utility enterprise management solutions, that is, techniques for monitoring and controlling any of a variety of operations conducted in or by a utility (such as monitoring and controlling one or more substations) or other complex enterprise, are increasingly important. Conventionally, such solutions are provided using relatively expensive proprietary software and custom software programming. Many small distribution substations are not even monitored because it has not been cost effective. Consequently, utilities in many instances first receive an indication of an outage by a call from an upset customer. A lack of fault information can prevent line crews from quickly identifying the location of a fault, and quickly remedying the problem. While weather-related outages may be difficult to avoid, some equipment failures can be prevented if it would be possible to continuously monitor the equipment and provide maintenance warnings when appropriate. A further concern is that necessary documents relating to equipment data and procedures are frequently not readily accessible.

It would be desirable to provide effective power management, including the continuous monitoring of substations or other equipment associated with a utility or other complex enterprise. It would also be desirable to provide a power management system that provides enhanced service features. It would also be desirable to provide such a power management system at a relatively low cost and in a manner than can be easily retrofitted into existing substations without disturbing existing systems. It would further be desirable for such a solution to be easily used by management staff with minimal training and no additional investment in specialized equipment. It be still further desirable to provide a flexible solution that can grow with changing enterprise requirements.

### SUMMARY OF THE INVENTION

A system and method for addressing the above problems and other problems may be provided by using a system a system for monitoring a utility substation. The system for monitoring a utility substation includes monitoring equipment, connected to a utility substation, for monitoring operating conditions of the utility substation. The monitoring equipment is connected to an application service provider through a first communication network. One or more network interface devices are connected to the application service provider by a second communication network, which may be the same communication network as the first communication network. The one or more network interface devices receive notification of operating conditions of the utility substation monitored by the monitoring equipment through the application service provider.

### BRIEF DESCRIPTION OF THE DRAWINGS

The present invention may be more fully understood with reference to the following drawing:

FIG. 1 is a generalized diagram of a system incorporating one embodiment of the present invention.

### DETAILED DESCRIPTION OF THE INVENTION

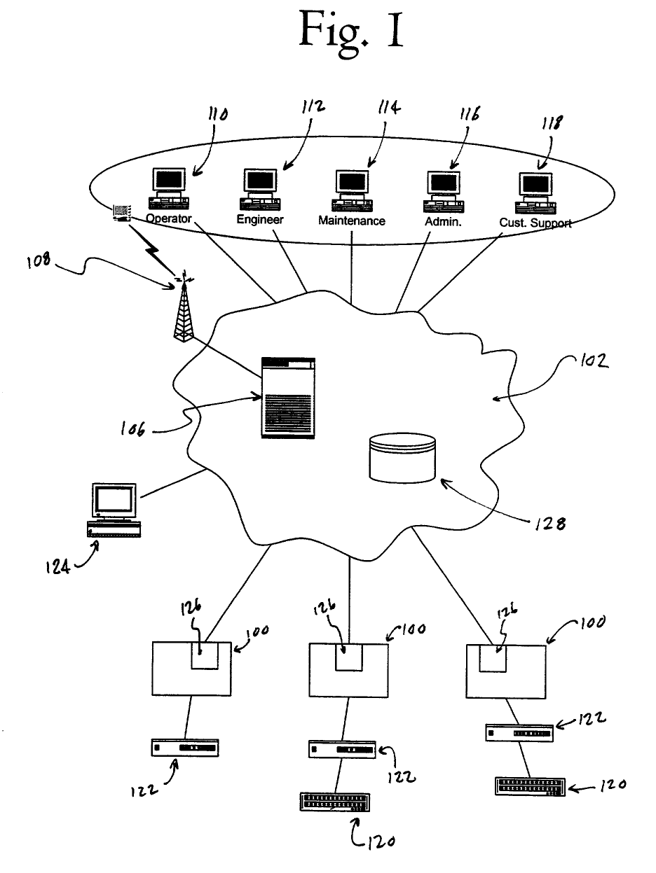

Referring now to FIG. 1, there is shown a generalized diagram of a system incorporating one embodiment of the present invention. In particular, one or more utility substations 100 (“substations”) are connected to a communications network 102 (“network”) through substation network interface devices 126. One or more client devices 104 may also be operably attached to the communications network 102. Further, one or more servers 106 associated with an application service provider (“ASP”) may be operably connected to the network 102, and may have uninterrupted communications with the substations 100, the client devices 104, or both, through the network 102. The server 106 may also have other communications systems for communicating with the substations 100 and the staff 104, such as a paging system 108, a cellular telephone system (not shown), and the like.

The utility substations 100, may be any type of substation 100 that is part of a utility or power generation system or grid. The substations obtain a resource and redistribute it to customers or other substations. For example, the substations 100 may be power substations 100 that route electric power from various power suppliers or other substations 100 to various utility customers or other substations 100. Similarly, the substations 100 may be for communications systems, such as cable networks, telephone networks, fiber optic networks, and the like. The substations 100 may also be non-electrical utility substations 100, such as water or sewer pumping stations. Further, it should be understood that the substations 100 may comprise a combination of plurality of different types of utility substations.

The substations 100 may be part of a wide or global network, such as a country-wide power grid, or may be relatively localized, such as an air-handling system for a commercial building. Furthermore, the substations 100 may be any size, and may have any level of complexity. For example, a substation 100 may be a relatively complex communications network routing substation 100 that handles cable, telephone, and fiber optic lines, or it may be a relatively simple air- or water-valve substation 100 in a commercial building. The substations 100 may be owned by a single utility provider, or different substations 100 may be owned by different utility providers. The present invention may be employed in either case.

The client devices 104 typically include a personal computer or similar device by personnel that operate, manage, or otherwise work with the utility substations 100. The precise composition of the personnel operating the client devices 104 may very depending on such factors as the business relationship between the various utility providers and the owner or operator of the servers 106, the requirements of the substations 100, the business practices of the utility providers, and so on. In an exemplary embodiment, in which the substations 100 are power distribution substations, the client devices 104 may comprise an operator device 110, and engineer device 112, a maintenance personnel device 114, an administrative personnel device 116, and a customer service personnel device 118.

A utility provider owning several substations 100 may employ a single set of client devices 104 being operated by a single group of personnel to oversee and operate all of the substations 100, or may have several groups of client devices 104 operated by several groups of personnel assigned to do so. In one embodiment, certain members of the personnel may be able to service all of the substations 100, while other groups of personnel may be assigned to particular substations 100. For example, the customer service personnel and administrative personnel may be the same for all of the substations 100, but the operators, engineers, and maintenance personnel may be assigned to particular substations 100 or particular groups of substations 100. The present invention may allow the number of personnel to be reduced or made more efficient, as is described in more detail herein. Variations on the composure and details of the particular personnel and associated client devices 104 will be obvious to one skilled in the art in light of the teachings herein.

The communications network 102 may comprise any system for transmitting data between various locations, and may be, include or interface with a distributed network, such as the Internet, or any type of local area network or larger area networks. In a preferred embodiment, the communications network 102 is the Internet.

The communications network 102 may be accessed by any suitable communications method, such as by use of a digital T1, T3, E1 or E3 line, a Digital Data Service (DDS) connection or DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or an FDDI (Fiber Distributed Data Interface) or CDDI (Copper Distributed Data Interface) connection. The network 102 may also use or include a wireless communications system, such as a cellular communications link, a radio frequency link, a paging device, or other suitable devices. These and other communications devices are known in the art, and a skilled artisan will be able to employ them with the present invention without excessive experimentation.

One or more servers 106 may control the communications network 102, and may generally serve as a communications link between the staff 104, the substations 100, and other entities or systems. The servers 106 may comprise any networking platform running any suitable operating system or network protocol. The servers 106 may be or include, for instance, workstations running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In the embodiments described herein, the servers 106 are described as performing certain tasks, however it should be understood that some or all of these tasks may be performed by network interface devices 126 operated at the substations 100 or by the client devices 104, or by other entities.

The substations 100 may each comprise or utilize one or more substation network interface devices 126 for communicating with the communications network 102. Further, the substation network interface devices 126 and the client devices 104 may be interconnected through respective internal networks, such as a Local Area Networks (“LAN”) or the like. Also, some or all of the substation network interface devices 126 and client devices may be portable devices, such as laptop computers. In one embodiment, the servers 106 may also be equipped to communicate with the personnel using a paging system or a cellular system. The paging system or other system may also be selected to communicate with the client devices 104, or the client devices may comprise pagers, cellular phones, personal digital assistants, and the like.

Substation network interface devices 126 at the substation 100 and the client devices 104 may be or include, for instance, personal computers running the Microsoft Windows™ 95, 98, Millenium™, NT™, 2000 or XP™, Windows™ CE™, PalmOS™, Unix, Linux, Solaris™, OS/2™, BeOS™, MacOS™, VAX VMS or other operating system or platform. Each network interface device 126 may include a microprocessor such as an Intel 86-based or Advanced Micro Devices 86-compatible device, a Motorola 68 K or PowerPC™ device, a MIPS, Hewlett-Packard Precision™, or Digital Equipment Corp. Alpha™ RISC processor, a microcontroller or other general or special purpose device operating under programmed control. Each network interface device 126 may furthermore include electronic memory such as RAM (random access memory) or EPROM (electronically programmable read only memory), storage such as a hard drive, CDROM or rewritable CDROM or other magnetic, optical or other media, and other associated components connected over an electronic bus, as will be appreciated by persons skilled in the art.

The substations 100, servers 106, and client devices 104 may communicate with one another using any number of systems. For example, they may send or receive messages to one another using Internet Protocol (IP) or Internet Protocol Next Generation (IPng) code or data, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™, Common Gateway Interface (CGI), servelets, peer-to-peer networking code or other compilers, assemblers, interpreters or other computer languages or platforms. In a preferred embodiment, the various entities communicate with one another using an Internet-based language that employs simple and familiar interface devices, such as a HTML-based language operating through Internet software such as Microsoft's Explorer™.

The preceding descriptions of the communication network 102, the servers 106, the substations 100, and the client devices 104 are not intended to limit the present invention. Communication network, such as network 102, and systems operating in conjunction with them are generally known in the art, and a skilled artisan will be able to employ such systems in conjunction with the present invention without undue experimentation.

In an alternative embodiment of the present invention communication network 102 may comprise a first communication network connecting the substation network interface device 126 with the server 106, and a second communication network connecting the client devices 104 with the server 106.

In one embodiment, the substations 100 further comprise a local device for monitoring and controlling the operation of the substation. For example, a substation 100 may comprise a supervisory control and data acquisition system (“SCADA”) 120 that monitors the devices at the substation 100 and allows a local operator to control various features or aspects of the substation's performance or automatically controls such features and aspects. As understood herein, “local” refers to a location within the general proximity of a substation 100, and local control may include the use of short-range radio frequency operated devices, and operation of hard-wired devices within the compound or facility containing the main operating devices or equipment of the substation.

The present invention may further comprise an adapter 122 for communicating with existing SCADA systems 120 that may be in place at a substation. In one embodiment, the adapter 122 may comprise a signal converter for converting digital and analog SCADA system signals into an Internet-usable format, such as an HTML-formatted signal. The adapter 122 may also include additional features, such as a local surveillance device (e.g., a camera, thermometer, anemometers), to detect physical conditions of equipment or the presence of trespassers or other physical intrusions or conditions. In another embodiment, in which the substation 100 does not have an existing SCADA system 120 or similar system, the adapter 122 may be configured to provide the functions and features that would otherwise be provided by a SCADA system 120 or similar system.

In one embodiment, the adapter 122 may include a waterproof or otherwise weather resistant enclosure such that it is resistant to environmental conditions. The adapter 122 may be configured to send signals directly to the communications network 102, or alternatively, it may transmit signals to another device in the substation 100 that processes such signals and relays them to the network 102. For example, the adapter 122 may transmit the SCADA system signals over a radio frequency to a network interface device 126 in the substation control room, which then converts these signals into a signal having an Internet-usable format for transmission to the servers 106 using the network 102. The adapter 122 preferably has a universal design that may be easily configured for connection with various types of SCADA systems 120, and which has an expandable port design or other suitable design for allowing flexibility and expandability.

Each substation 100 further comprises at least one monitoring device for monitoring the operating conditions of the substation 100. For example, in an embodiment in which the utility substations 100 are electric power substations, the substations 100 may be equipped with monitoring devices that measure the voltage and current through the substations 100 at various points. The substation network interface devices 126 may be equipped to transmit the output of the one or more monitors to the servers 106. Alternatively, or in addition, the servers 106 may be equipped to directly query the monitoring devices to determine the operating conditions of the substations 100. The monitoring devices may be part of a SCADA system 120 or an adapter 122.

One embodiment of a system incorporating the present invention may also include one or more customer client devices 124 for enable customer access to servers 106. The customer may use the customer client devices 124 to obtain information about the substations 100 and other information from the utility providers. For example, a utility provider may establish a home page on the Internet that allows access by customer client device 124 by way of the Internet. The home page may provide information such as the customer's account information, the customer's utility usage patterns, the status of one or more substations (e.g., whether they are experiencing an outage, and when the outage is expected to end), and so on. In addition, a utility provider may use an Internet connection with the customer client device 124 to obtain suggestions, sell energy, provide reliability statistics, promote new services, or provide or receive other information.

In order to assist the utility owner with maintaining, repairing and operating the substations 100, the present invention may further include an equipment database 128. The equipment database 128 may comprise one or more of any type of computer database. In a preferred embodiment, the equipment database 128 is a single database maintained by the server 106, and which may be updated by an operator of the server 106 or by personnel operating the client devices 104. In another embodiment, however, the equipment database 128 may be maintained locally by a global network interface device 126 located at one or more of the substations 100. In one embodiment, the equipment database 128 may comprise a multitude of identical and redundant databases that are established and updated on each of the server 106, client devices 104, and the substation network interface devices 126.

The equipment database 128 may contain information about the particular equipment at each substation 100. This information may include service manuals, operating specifications, suggested maintenance schedules, warnings, warranty information, wiring diagrams, substation maps, safety procedures, emergency contact information, the performance history of that particular piece of equipment, and the like. The information in the equipment database 128 may be organized in such a manner as to facilitate sorting by various methods, such as by type of equipment, by location, by scheduled maintenance date, or by other methods. By providing this information in an equipment database 128, the present invention may allow less experienced personnel to operate, repair, and maintain the substations 100 and related equipment.

An exemplary embodiment of the present invention may provide various fault detection and correction features. The substations 100 of a utility provider, especially power utilities, often are spread out over hundreds or even thousands of square miles. This geographical dispersion may make detecting and pinpointing faults difficult, as the utility provider often has no prior warning of the fault, and it may be difficult to interpret the symptoms of the fault (e.g., termination of the utility to particular customers, or breakdown of optimal current characteristics) to determine where the fault occurred. In order to identify and pinpoint faults, the servers 106 may receive signals from the substation network interface devices 126 at each substation 100 that indicate whether the substation 100 is experiencing abnormal or fault conditions. Alternatively, or in addition, the servers 106 may query the substation network interface devices 126 to determine when a fault is detected.

The substation network interface devices 126 or the servers 106 may be programmed to establish which measurements and conditions qualify as fault conditions. Fault conditions may be defined to include total power failures, such as short circuits and open circuits, and may also include service situations, such as unusual voltage or current fluctuations, or other conditions. Each utility provider may select different parameters that indicate a fault condition for its substations 100 based on the type of equipment at each substation, desired maintenance schedules, or for other reasons.

In one embodiment of the invention, when a fault is detected, the servers 106 notify the appropriate members of the personnel operating the client devices 104 through network 102. In order to provide instant notification of a fault, the servers 106 may notify client devices 104, such as a pager 108 or cellular telephone monitored by maintenance personnel. By using such an instant notification system, the personnel may attend other activities without having to constantly monitor the operation of the system to quickly detect faults. In addition, a signal may be transmitted to other client devices 126 being operated by other personnel, and the substation network interface devices 126 so as to notify them that a fault has occurred. In one embodiment, such a signal may trigger a visual alert to display or cause an audible alarm to sound. Such a signal may provide visual and audible warnings on an internet web browser on the client devices 104 and the substation network interface devices 126. Once notified, maintenance personnel can quickly pinpoint the substation raising the alarm by referring to, for example, an internet-based web browser utility programmed to display the location and details of the alarm in a user interface. In one embodiment, the user interface may include a plurality of interactive screens that allow the personnel to view various operating conditions of the substations, and which may be programmed to respond to the user's input to cause the server 106 to query the substations network interface devices 126 to obtain further operating conditions form the monitoring devices.

When a utility provider is notified that a substation 100 has experienced a fault condition, the utility owner may have to determine an appropriate course of action. To plan a response, it may be desirable to identify the exact nature of the fault prior to dispatching maintenance personnel to correct the fault. If the fault is a service warning, such as an indication that a part of the system may be in the early stages of failure as may be indicated by a particular trend in the measurements, then an immediate dispatch may not be necessary. If the fault is an emergency warning, such as a fire or a power outage, then immediate dispatch may be desired. In one embodiment one or more of the server 106, the client devices 104, and the substation network interface devices 126 may be programmed to identify particular conditions to determine whether they warrant service warnings, emergency warnings, or no warning. For example, a server 106 may be programmed to recognize a particular trend in the voltage of a substation 100 to recognize it as the early stages of a short circuit.

In one embodiment of the invention, when a fault is detected, the server 106 automatically calls up the appropriate information from the equipment database 128 that relates to the particular fault condition. For example, if a blown fuse is detected, then the server 106 may provide the maintenance personnel the service manual and safety warnings for the type of fuse that has blown. In addition, the server 106 may simultaneously provide warranty information for the fuse to the administrative personnel so that they may determine whether the fuse may be replaced or repaired under warranty. Upon a loss of power at a substation 100, the server 106 may also notify the customer service personnel that there is a power outage, and may automatically provide them with an estimated time of repair so that that information may be passed along to customers.

If the utility provider wishes to obtain more information about the fault condition, an engineer or other personnel may access the equipment database 128 through client device 104 to examine other records or files that may be useful in determining what caused the fault or how to repair the fault. In one embodiment of the invention, a local SCADA system 120 or adapter 122 may provide historical information surrounding the fault condition that may be useful for diagnosing various problems. For example, electrical power utility engineers often use system settings, actual conditions, oscillographic information, and events at the time of the trip to determine how a particular fault occurred. SCADA systems 120 or adapters 122 are often programmed to record this information, however such information is typically only stored locally at the substation 100. Using the present invention, an engineer may be able to access this information remotely through the server 106, saving the time needed to make a local visit to the substation 100, and possibly reducing the number of engineers required to suitably staff the utility provider.

The equipment database 128 may also serve several other functions to provide benefits to the utility owner when a fault condition is detected. In one embodiment, the equipment database 128 comprises an expertise database. The expertise database provides troubleshooting information that may assist the client devices 104 with diagnosing fault conditions and effectuating corrective measures. In many instances, the fault conditions experienced by a utility have previously occurred. The expertise database may be a passive or an interactive database of fault events, symptoms, and solutions. The expertise database may also comprise public documents and internet links to websites having industry standards, application papers, notes, and diagnosis guides for the equipment. An engineer or other member of the personnel may quickly access the expertise database to obtain assistance with diagnosing a fault condition. In addition, the server 106 may be programmed to correlate particular fault events with corresponding entries in the expertise database, so that when a fault is detected and reported, the server 106 provides a suggested course of action.

Utility providers often desire to provide reports on the utility's operation. Government regulated outage reports, monitored data in chart form, and routine internal reports are an administrative burden that each utility handles with its internal personnel. For example some governmental authorities require formal reports to be submitted when a utility fails to provide service for an extended period. The present invention, and in particular the monitoring features described herein, may be integrated into a reporting system that automatically generates operation or service reports and prepares them for government filing and other uses. One or more of the server 106, the client devices 104, and the substation network interface devices 126 may be programmed to create reports from automatically collected or manually entered data. Once set up, reports may be created automatically or may be viewed on demand, printed or emailed or otherwise transmitted as required, thereby reducing the cost of operation.

The present invention may also be programmed to organize emergency operations and other maintenance operations. For example, planned or emergency work on an electrical power distribution system may be a regular activity in the sense that such operations require specific safety procedures and other procedures to ensure that the work is done safely and to the specifications set forth by the utility provider. Each particular work procedure, such as replacement of a blown fuse or servicing a transformer, may require a specific detailed work plan. This work plan may include the use of safety steps, such as printing and installing lockout tags, coordinating a temporary power outage with other substations to ensure that the customers 124 are not left without power, and filing a record of the work procedure and the results. Conventionally, utility providers manually create a work plan for each task, which can be time consuming and may lead to errors or omissions in the plan. One or more of the server 106, the client devices 104, and the substation network interface devices 126 of the present invention may be programmed to provide a scheduling program feature. The scheduling program may be used to automate the repetitive manual creation of procedures by allowing entry of the information only once using prompter screens to capture all the required activities and minimize omissions. The necessary schedules, detailed procedures and lockout tags may then be generated by printers attached to the system as needed for each maintenance event or repair. The servers 106 or other devices on the system may also take automatic measures to ensure that safety conditions are not breached during service, such as by establishing a power cut off that can not be accidentally overridden.

Furthermore, the scheduling program may be implemented with the present invention to check the equipment database 128 to determine which pieces of equipment are due for repair or maintenance. The scheduling program may then create an efficient plan for dispatching maintenance personnel to perform the required tasks. If such a scheduling program is implemented over a computer network, the server 106 may create an electronic network “punch pin” board or other type of planning device that may be updated by the supervisor and viewable by the entire team using client devices 104 and substation network interface devices 126 over the internet to determine system status. On completion of a job, a detailed record may be automatically generated for filing. The use of such a scheduling system promotes consistent methodology and improved efficiency and safety and provides other benefits to a utility provider.

As noted before, the server 106 may also provide the administrative staff with information to assist them with administering the utility provider. For example, the equipment database 128 may be used to create an asset list that indicates the type, number, location, and status of each asset of the utility provider. This may be used to assist with financial record keeping, maintenance, and tracking for budget purposes. Such an administrative tracking system may also be used in conjunction with the fault detection and correction features. For example, upon detection of a fault, the server 106 may query the equipment database 128 to locate any spare parts necessary to repair the faulty equipment and notify the maintenance personnel of the location of such parts.

The server 106 may also be equipped to provide remote operation of various parts of the substations 100. For example, the server 106 may be programmed to send the substations 100 a signal that initiates local self-testing procedures at the substations 100. The server 106 may also compare the operation conditions of various substations 100 to determine which substations 100 are operating at greater efficiency than others in order to re-route the flow of the utility through the substations to improve the overall efficiency of the utility network.

The present invention may provide numerous benefits to a user. By providing reliable automated monitoring for fault conditions and direct notification when faults occur, the present invention may allow a utility provider to reduce the number of personnel required to be at the substations 100 to detect faults. By detecting and announcing possible maintenance issues, the present invention may also reduce the cost of repairs, abrogate the need for frequent visits for manual inspections, and improve the overall efficiency of the utility provider. The present invention may also be used to increase safety, efficiency and productivity.

In a preferred embodiment, the present invention uses a familiar Internet-based format and is designed using standard available design tools, such as those available in HTML code. The invention may also use interactive set-up programs that guide the user through a series of steps that quickly and easily configure the system for optimal operation. Such formats and programs are relatively simple to use and program, thereby minimizing the initial startup cost and training costs. A system using the Internet also may be accessed by most telephone lines and is therefore highly accessible, even for personnel who are traveling. Internet-based systems may also be expanded with very little cost. The present invention may also be added to existing systems without substantial interference with the utility provider's business, and without incurring substantial costs related to training personnel to use the system.

While the foregoing description includes many details and specifics, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A system for monitoring a utility substation comprising:
monitoring equipment operatively connected to a utility substation for monitoring operating conditions of the utility substation;
the monitoring equipment being operatively connected to an application service provider through a first communication network;
one or more network interface devices operatively connected to the application service provider by a second communication network for receiving notification of operating conditions of the utility substation monitored by the monitoring equipment.

2. The system of claim 1, wherein the monitoring equipment comprises one or more devices for measuring the voltage and current in an electrical power utility substation.

3. The system of claim 1, wherein at least one of the first and second communication networks is the Internet.

4. The system of claim 1, wherein the first communication network and the second communication network comprise the same network.

5. The system of claim 1, further comprising an equipment database operatively connected to at least one of the first and second communication networks, the equipment database being accessible by one or more of the application service provider and the one or more network interface devices.

6. The system of claim 1, further comprising an expertise database.

7. The system of claim 1, wherein at least one of the one or more network interface devices and the application service provider includes a reporting system for automatically generating reports relating to the operation of at least one of the utility substations.

8. The system of claim 1, wherein at least one of the one or more network interface devices and the application service provider includes a scheduling program for scheduling maintenance operations for at least one of the utility substations.

9. The system of claim 1, wherein at least one of the one or more network interface devices and the application service provider includes an administrative tracking program for providing administrative functions for at least one of the utility substations.

10. The system of claim 1, wherein at least one of the one or more network interface devices and the application service provider includes a remote operation module for remotely operating at least one of the substations.

11. A system for monitoring a utility substation comprising:
monitoring equipment, comprising one or more devices for measuring the voltage and current in an electrical power utility substation, operatively connected to a utility substation for monitoring operating conditions of the utility substation;
the monitoring equipment being operatively connected to an application service provider through a first communication network;
one or more network interface devices operatively connected to the application service provider by a second communication network for receiving notification of operating conditions of the utility substation monitored by the monitoring equipment;
an equipment database operatively connected to at least one of the first and second communication networks, the equipment database being accessible by one or more of the application service provider and the one or more network interface devices;
an expertise database,
wherein at least one of the one or more network interface devices and the application service provider includes a reporting system for automatically generating reports relating to the operation of at least one of the utility substations,
wherein the first and second communication networks are the Internet,
wherein at least one of the one or more network interface devices and the application service provider includes a scheduling program for scheduling maintenance operations for at least one of the utility substations,
wherein at least one of the one or more network interface devices and the application service provider includes an administrative tracking program for providing administrative functions for at least one of the utility substations, and
wherein at least one of the one or more network interface devices and the application service provider includes a remote operation module for remotely operating at least one of the substations.

12. A method for monitoring a utility substation comprising the steps of:
operatively connecting monitoring equipment to a utility substation for monitoring operating conditions of the utility substation;
operatively connecting the monitoring equipment to an application service provider through a first communication network;
operatively connecting one or more network interface devices to the application service provider by a second communication network for receiving notification of operating conditions of the utility substation monitored by the monitoring equipment.

13. The method of claim 12, wherein the monitoring equipment comprises one or more devices for measuring the voltage and current in an electrical power utility substation.

14. The method of claim 12, wherein at least one of the first and second communication networks is the Internet.

15. The method of claim 12, wherein the first communication network and the second communication network comprise the same network.

16. The method of claim 12, further comprising the step of operatively connecting an equipment database to at least one of the first and second communication networks the equipment database being accessible by one or more of the application service provider and the one or more network interface devices.

17. The method of claim 1, further comprising the step of incorporating an expertise database into at least one of the one or more network interface devices and the application service provider.

18. The method of claim 1, further comprising the step of incorporating a reporting system for automatically generating reports relating to the operation of at least one of the utility substations into at least one of the one or more network interface devices and the application service provider.

19. The method of claim 1, further comprising the step of incorporating a scheduling program for scheduling maintenance operations for at least one of the utility substations into at least one of the one or more network interface devices and the application service provider.

20. The method of claim 1, further comprising the step of incorporating an administrative tracking program for providing administrative functions for at least one of the utility substations into at least one of the one or more network interface devices and the application service provider.

21. The method of claim 1, further comprising the step of incorporating a remote operation module for remotely operating at least one of the substations into at least one of the one or more network interface devices and the application service provider.

22. A method for monitoring a utility substation comprising the steps of:
operatively connecting monitoring equipment, comprising one or more devices for measuring the voltage and current in an electrical power utility substation, to a utility substation for monitoring operating conditions of the utility substation;
operatively connecting the monitoring equipment to an application service provider through a first communication network;
operatively connecting one or more network interface devices to the application service provider by a second communication network for receiving notification of operating conditions of the utility substation monitored by the monitoring equipment,
wherein the first and second communication networks are the Internet,
wherein the first communication network and the second communication network comprise the same network;
operatively connecting an equipment database to at least one of the first and second communication networks the equipment database being accessible by one or more of the application service provider and the one or more network interface devices;
incorporating an expertise database into at least one of the one or more network interface devices and the application service provider;
incorporating a reporting system for automatically generating reports relating to the operation of at least one of the utility substations into at least one of the one or more network interface devices and the application service provider;
incorporating a scheduling program for scheduling maintenance operations for at least one of the utility substations into at least one of the one or more network interface devices and the application service provider;
incorporating an administrative tracking program for providing administrative functions for at least one of the utility substations into at least one of the one or more network interface devices and the application service provider; and
incorporating a remote operation module for remotely operating at least one of the substations into at least one of the one or more network interface devices and the application service provider.
